(19) United States
(12) Patent Application Publication
(10) Pub. No.: US 2012/0078444 A1
(43) Pub. Date: Mar. 29, 2012

(54) PREVENTION SYSTEM AGAINST INVALID USE OF STOLEN BATTERY

(75) Inventor: Hidekazu Mase, Toyohashi-shi (JP)

(73) Assignee: DENSO CORPORATION, Kariya-city (JP)

(21) Appl. No.: 13/239,516

(22) Filed: Sep. 22, 2011

(30) Foreign Application Priority Data
Sep. 23, 2010 (JP) 2010-212940

(51) Int. Cl. G06F 7/00

(52) U.S. Cl. 701/2

(57) ABSTRACT

A system has a server and an on-vehicle unit. The on-vehicle unit verifies whether a battery currently mounted in the vehicle is valid based on identification information given to the battery. The on-vehicle unit transmits to the server a request for verifying the identification information with a data base when it is verified that the battery currently mounted in the vehicle is invalid. The server searches the data base as to whether there is identification information in question which matches data in the data base, and notifies the on-vehicle unit of information showing that the identification information in question matches a stolen battery when a search result reveals that the identification information in question matches the data. The on-vehicle unit limits use of the unauthorized battery, that is, use of the vehicle when it is notified by the server that the identification information in question matches the stolen battery.

### CROSS-REFERENCE TO RELATED APPLICATION

This application is based on and claims the benefit of priority from earlier Japanese Patent Application No. 2010-212940 filed Sep. 23, 2010, the description of which is incorporated herein by reference.

### BACKGROUND OF THE INVENTION

1. Technical Field of the Invention

The present invention relates to a prevention system against invalid use of a stolen battery, in which an on-vehicle unit and an external server communicate with each other to determine whether the battery installed in the vehicle is a stolen battery and puts a limit, if the battery is determined to be a stolen battery, to the travel of the vehicle with the stolen battery (i.e., the use of the stolen battery).

2. Related Art

In the field describe above, for example, patent document JP-A-2009-254123 discloses a vehicle battery charge system. In charging the battery of an electric vehicle, this battery charge system performs power line carrier communication with the electric vehicle via a charging power line connected to the vehicle. In performing power line carrier communication, the user and the body of the electric vehicle are verified. In this system, information, such as a vehicle body number, is transmitted from the electric car to a server through power line carrier communication. In this case, position information, i.e. information on a charging place, is ensured to be added to the information. Thus, when the electric vehicle is confirmed to be a stolen vehicle based on the vehicle body number, the charging place is specified for the tracing of the stolen vehicle, while the electric charge of the stolen vehicle is disabled.

A battery used such as for an electric vehicle is very expensive. Thus, when it is difficult to steal an electric vehicle, for example, the battery of the vehicle may be stolen, instead, being removed from the vehicle.

When a battery is stolen from a vehicle and when the stolen battery is installed in a different vehicle, the system disclosed in the above patent document may allow charge of the battery if only the user and the vehicle body are verified. Therefore, use of a stolen battery cannot be prevented.

Also, the system disclosed in the above patent document suffers from a problem that a determination as being a stolen vehicle and tracing of the stolen vehicle can be performed only when the battery of the electric vehicle in question is charged. In other words, it is not possible to put a limit to the travel of the stolen vehicle before it comes to be necessary for the battery of the stolen vehicle to be charged.

### SUMMARY

Thus it is desired to provide a prevention system against invalid use of a stolen battery, which is able to effectively prevent invalid use of a battery that has been stolen from a vehicle.

An exemplary embodiment provides a system for preventing use of an on-vehicle battery that has been stolen. The system comprises a server placed outside the system; and an on-vehicle unit mounted on a vehicle. The server comprises the server comprises: first communication means for communicating with the on-vehicle unit, a data base in which data showing identification information about stolen batteries are registered, receiving means for receiving a request for searching identification information in question about a stolen battery from the on-vehicle unit via the first communication means, searching means for searching the data base as to whether or not there is the identification information in question which matches the data in the data base, when the receiving means receives the request, and notifying means for notifying the on-vehicle unit, from which the request has been transmitted, of information showing that the identification information in question reveals a stolen battery, when the searching means searches for identification information in question which matches the data. Meanwhile, the on-vehicle unit comprises: second communication means for communicating with the server, verifying means for verifying whether or not a battery currently mounted in the vehicle is valid (or correct), by reading out the identification information given to the battery and verifying the read-out identification information with identification information previously registered in the on-vehicle unit, transmitting means for transmitting, via the second communication means, to the server the request about the read-out identification information when it is verified that the battery currently mounted in the vehicle is invalid (or incorrect), and limiting means for limiting use of the vehicle when it is notified from the server that the identification information in question reveals the stolen battery.

According to the prevention system against unauthorized use of a stolen battery, the ID information of the battery installed in the vehicle is registered in advance in the on-vehicle unit, as mentioned above. The verifying means reads the ID information from the battery such as when the vehicle is used to verify the read ID information with the ID information registered in advance to thereby verify whether the battery is a valid battery.

Specifically, according to the prevention system against unauthorized use of a stolen battery, the battery is verified in the on-vehicle unit as to whether it is a valid battery. Thus, the battery is verified at any time as needed, such as when the vehicle is used, without being limited to the time when the battery is charged. If the verification is disapproved, the ID information read from the battery is transmitted to the external server. The external server, upon reception of the ID information of the battery from the on-vehicle unit, searches through the data base as to whether the battery is a stolen battery, and notifies the results of the search to the on-vehicle unit. Upon reception of a notification regarding the fact of being a stolen battery from the external server, the on-vehicle unit allows the limiting means to put a limit to the travel of the vehicle with the stolen battery.

Thus, when a stolen battery is installed in a different vehicle, travel of the vehicle with the stolen battery is effectively prevented. In this way, when a battery is stolen for use in a different vehicle, use of the battery becomes no longer possible. Resultantly, batteries can be prevented from being stolen.

Preferably, the vehicle comprises a position detector that detects a current position of the vehicle provided with the on-vehicle unit, and the on-vehicle unit comprises means for transmitting, to a server at a specified organization, both identification information of the vehicle and information showing the current position detected by the position detector, when it is notified from the server that the identification information in question reveals that the battery was stolen.

For example, the vehicle installing a stolen battery can be searched by transmitting the ID information and the current position of the vehicle to the server of a specified organization, such as police or a security company. In this case, since the travel of the vehicle is limited by the limiting means, the vehicle installing the stolen battery can be easily located.

Still preferably, wherein the vehicle has a plurality of batteries mounted hereon, and the verifying means is configured to verify whether or not each of the batteries currently mounted in the vehicle is valid.

Depending on vehicles, a plurality of physically separate batteries may be installed in order to increase the battery capacity. In this case, there is a probability that batteries are stolen on an isolated battery basis for use in a different vehicle. Verification of each of a plurality of batteries can cope with the occurrence of such theft of batteries on an isolated battery basis.

### BRIEF DESCRIPTION OF THE DRAWINGS

In the accompanying drawings:

FIG. 1 is a schematic block diagram illustrating a configuration of a prevention system against unauthorized use of a stolen battery according to an embodiment of the present invention;

FIG. 2 a flow diagram illustrating a registration process for ID information performed in an on-vehicle unit, according to the embodiment;

FIG. 3 is a flow diagram illustrating a verification process for ID information performed in the on-vehicle unit;

FIG. 4 is a flow diagram illustrating a stolen battery determination process performed in a server, according to the embodiment; and

FIG. 5 is a flow diagram illustrating a vehicle travel limitation process performed in the on-vehicle unit.

### DETAILED DESCRIPTION OF THE PREFERRED EMBODIMENTS

With reference to the accompanying drawings, hereinafter is described a prevention system against unauthorized use of a stolen battery according to an embodiment of the present invention.

The prevention system against invalid (or unauthorized) use of a stolen battery of the present embodiment is used for motor-driven vehicles, such as electric vehicles or hybrid vehicles installing an electric motor which is driven by electric power of a battery. When a battery is stolen from such a vehicle and installed in a different vehicle, this prevention system puts a limit to the travel of the different vehicle with the stolen battery. Limiting the travel of a different vehicle with a stolen battery can contribute to preventing theft of batteries.

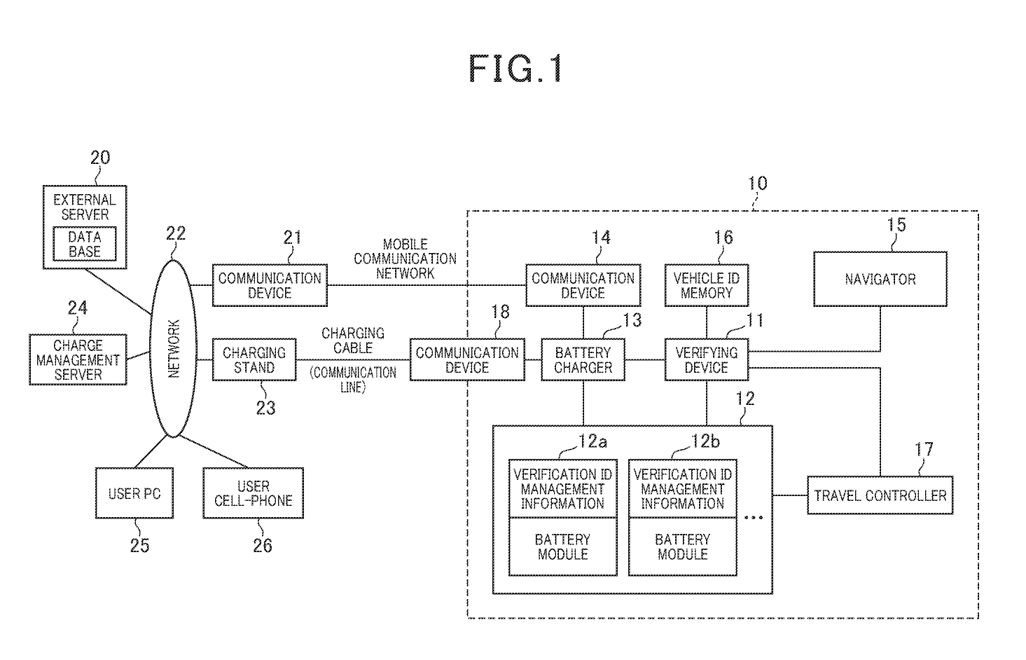

FIG. 1 is a schematic block diagram illustrating a configuration of the prevention system against invalid (unauthorized) use of a stolen battery according to the embodiment. As shown in FIG. 1, the prevention system against invalid use of a stolen battery is configured such that an on-vehicle unit 10 installed in an electric vehicle is able to communicate with an external server 20 having a data base, such as a police server, in which ID information of stolen batteries is registered.

The on-vehicle unit 10 includes a verifying device 11, a battery 12, a battery charger 13, a communication device 14 that performs communication via a mobile communication network, a navigator 15, vehicle ID memory 16, a travel controller 17, and communication device 18 that performs communication via a charging cable.

The verifying device 11, which is made up of a computer, reads ID information of the battery 12 installed in the motor-driven vehicle (hereinafter also just referred to as “vehicle”) when a specific operation for a registration process is performed, and stores the read ID information in a memory of the verifying device 11. For example, the specific operation for a registration process may include a switch operation in sequence or in combination which is not usually used, or connection of a device dedicated to generating a signal for instructing start of the registration process, followed by reception of the signal from the dedicated device by the verifying device 11.

The verifying device 11 uses the stored ID information to verify (i.e., check) the ID information of the battery 12 and to verify whether the battery is a correct battery. The verifying device 11 also transmits the ID information of the battery to an external server 20 when the results of the verification are disapproved. Also, the verifying device 11 transmits the vehicle ID and position information to the server of a specified organization, such as police or a security company, when a notification regarding the fact of being a stolen battery is received from the external server 20. Further, the verifying device 11 instructs the travel controller 17 to disable the vehicle from traveling.

It should be appreciated that the external server 20 alone may be provided to play a role of the server of a specified organization. Alternatively, the external server 20 may be provided separately from the server of a specified organization.

The battery 12 is charged being supplied with electric power from a charging stand 23 to thereby supply electric power to electrical loads, such as an electric motor, not shown. The motor-driven vehicle has a jack, not shown, into which a plug provided at a tip end of a charging cable is inserted when the battery 12 is charged. In the present embodiment, the battery 12 consists of a plurality of battery modules 12a, 12b, . . . which are physically isolated from each other. The purpose of constituting the battery 12 with a plurality of battery modules 12a, 12b, . . . is to increase the capacity of the battery as a whole and to extend the distance through which the vehicle is able to cruise.

Each of the battery modules 12a, 12b, . . . is provided with a memory for storing battery identification information, such as a production number or a serial number of the battery, that can be used as a checking ID. The memory also stores battery management information, such as of a battery manufacturer, model number, capacity and charging current. When the verifying device 11 verifies the battery 12, the battery management information is also read, in addition to the checking ID, to perform verification. The battery management information may be different between the battery modules 12a, 12b, . . . and thus may be used as information for identifying each battery module. Thus, a more reliable determination may be made regarding whether or not the battery 12 installed in the motor-drive vehicle is a correct battery in conducting a verification. Alternatively, however, the verifying device 11 may conduct a verification based on a checking ID alone.

The battery charger 13 uses electric power supplied from the charging stand 23 to charge the battery 12. Specifically, the battery charger 13 takes into account the battery capacity and the charging current among the battery management information, while controlling the amount of charge of the battery 12. In controlling the amount of charge, the battery charger 13 detects a state of charge (SOC) of the battery 12 to realize a predetermined SOC (e.g., maximally charged state of the battery 12, or a charged stage according to the user's instruction). It should be appreciated that the control of the amount of charge as mentioned above may be performed based such as on time elapsed from the start of charge.

Also, the battery charger 13 transmits information, such as a vehicle ID, to a charge management server 24 via the communication device 18. The charge management server 24 manages electric energy used for charging a battery on a vehicle (user) basis. The charge management server 24 verifies a vehicle (user) based on the received information. When the verification has been approved, the charge management server 24 permits the charging stand 23 to charge the vehicle. Then, the charging stand 23 starts supply of electric power for charging the battery 12 via the charging cable. Meanwhile, if the verification is disapproved in the charge management server 24, charge of the battery is not permitted and thus the charging stand 23 does not supply electric power for charging the battery 12.

The communication device 14 is able to communicate with a communication device 21, which is connected to a network 22, such as via a mobile communication network. For example, a cell-phone or a DCM (data communication module) may be used as the communication device 14. However, the communication device 14 may communicate with the communication device 21 via a communication network other than the mobile communication network. In this way, the system of the present embodiment includes the communication device 14 that performs communication via a mobile communication network, in addition to the communication device 18 that performs communication via a charging cable. Thus, the on-vehicle unit 10 is able to communicate with the external server 20 at any time, without being limited to the time of charging the battery of the vehicle.

For example, the navigator 15 includes a GPS (global positioning system) receiver. Accordingly, the navigator 15 has a function of detecting the current position of the vehicle, for indication on a road map of the area surrounding the current position. The GPS receiver receives GPS signals issued from a plurality of GPS satellites to measure the current position of the vehicle, using the received GPS signals. The navigator 15 outputs position information to the verifying device 11, the position information indicating the current position of the vehicle, which has been measured by the GPS receiver. When a notification regarding a stolen battery being detected is received from the external server 20, the verifying device 11 transmits the position information to the server of the specified organization together with the vehicle ID.

The travel controller 17 controls travel of the vehicle that uses an electric motor as a drive source of travel. When an instruction for inhibiting the travel of the vehicle is received from the verifying device 11, the travel controller 17 limits use (travel) of the vehicle such as by stopping driving of the electric motor.

The external server 20 is connected to the network 22 and has a data base in which ID information such as of stolen batteries is registered. The ID information of a stolen battery is registered by the user's operation. In the registration, the user may transmit the ID information stored in the verifying device 11 of the on-vehicle unit 10 to the external server 20, as registration ID information. Alternatively, the ID information of the battery 12 may be retained such as by the vehicle dealer, and should the battery 12 be stolen, registration in the stolen battery data base of the external server 20 may be carried out using the ID information retained by the vehicle dealer.

A user PC 25 and a user cell-phone 26 are able to communicate with the external server 20 and the charge management server 24 via the network 22. For example, the amount of charge at the charging stand 23 or the electricity prices in a certain period can be confirmed using the user PC 25 or the user cell-phone 26, or, when the stolen battery has been found, a notification accordingly can be received by the user PC 25 or the user cell-phone 26.

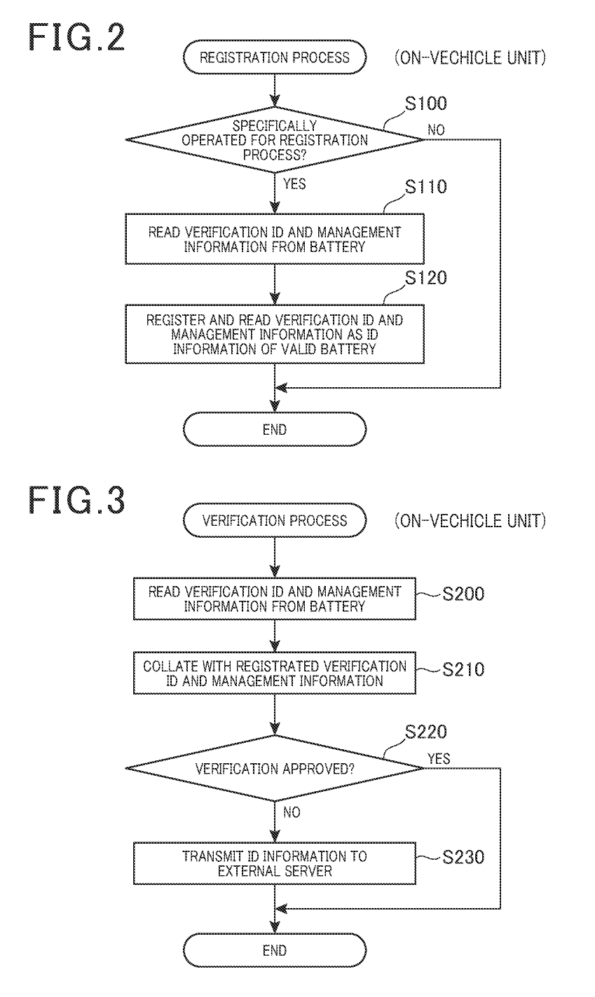

In the prevention system against unauthorized use of a stolen battery having a configuration as described above, some processes are performed by the on-vehicle unit 10 and the external server 20, in particular. Referring to the flow diagrams of FIGS. 2 to 5, hereinafter are described these processes in details.

FIG. 2 is a flow diagram illustrating a registration process performed by the on-vehicle unit 10. In the registration process, the ID information of the battery 12 installed in the vehicle is registered in the verifying device 11. The registration process is performed by the vehicle maker at the time of shipment of the vehicle, or by the vehicle dealer or a vehicle repairer when the battery 12 is changed.

First, at step S100, it is determined whether or not a specific operation for the registration process has been performed. At this determination step S100, if it is determined that the specific operation for the registration process has been performed, control proceeds to step S110. If it is determined that the specific operation has not been performed, the process shown in the flow diagram of FIG. 2 is terminated.

At step S110, the ID information consisting of the checking ID and the battery management information is read from the battery 12 installed in the vehicle. Then, at step S120, the ID information consisting of the checking ID and the battery management information read from the battery 12 is stored and registered, as ID information of a correct battery, in a non-volatile memory of the verifying device 11.

As shown in FIG. 1, when the battery 12 is configured by a plurality of battery modules 12a, 12b, . . . , the ID information of each of the battery modules 12a, 12b, . . . is registered in the verifying device 11.

Once the registration process is performed, the verifying device 11 performs a verification process. In the verification process, the verifying device 11 verifies the ID information read from the battery 12 and the registered ID information when the vehicle is used to thereby verify whether the battery is the correct battery 12.

FIG. 3 is a flow diagram illustrating the verification process of the battery 12 performed by the on-vehicle unit 10. The verification process is performed, for example, when a start switch enabling travel of the vehicle is operated.

First, at step S200, the ID information consisting of the checking ID and the battery management information is read from the battery 12 installed in the vehicle. In this case, when a plurality of battery modules 12a, 12b, . . . are installed in the vehicle, the ID information is read from each of the battery modules 12a, 12b, . . . .

At the subsequent step S210, the ID information registered at the verifying device 11 is verified with the read ID information. Then, at step S220, it is determined whether or not the battery 12 installed in the vehicle can be verified as being a valid battery, based on the results of verification performed at step S210. When a plurality of battery modules 12a, 12b, . . . are installed in the vehicle, the ID information in each of the modules is verified. If the verification of the ID information has resulted in mismatch in any one of the modules, verification is disapproved only for the ID information of the module in question.

In the determination at step S220, if the verification of the ID information of all of the modules has been approved (affirmed), the process shown in the flow diagram of FIG. 3 is terminated. If the verification of the ID information of any one of the modules has been disapproved (negated), control proceeds to step S230.

At step S230, the ID information consisting of the checking ID and the battery management information read from the battery 12 is transmitted to the external server 20, for the battery 12 installed in the vehicle has a possibility of being a stolen battery. In this case, the vehicle ID may also be transmitted to the external server 20. Thus, should the battery 12 turns out to be a stolen battery, the external server 20 is able to acquire the ID information of the vehicle that has the stolen battery.

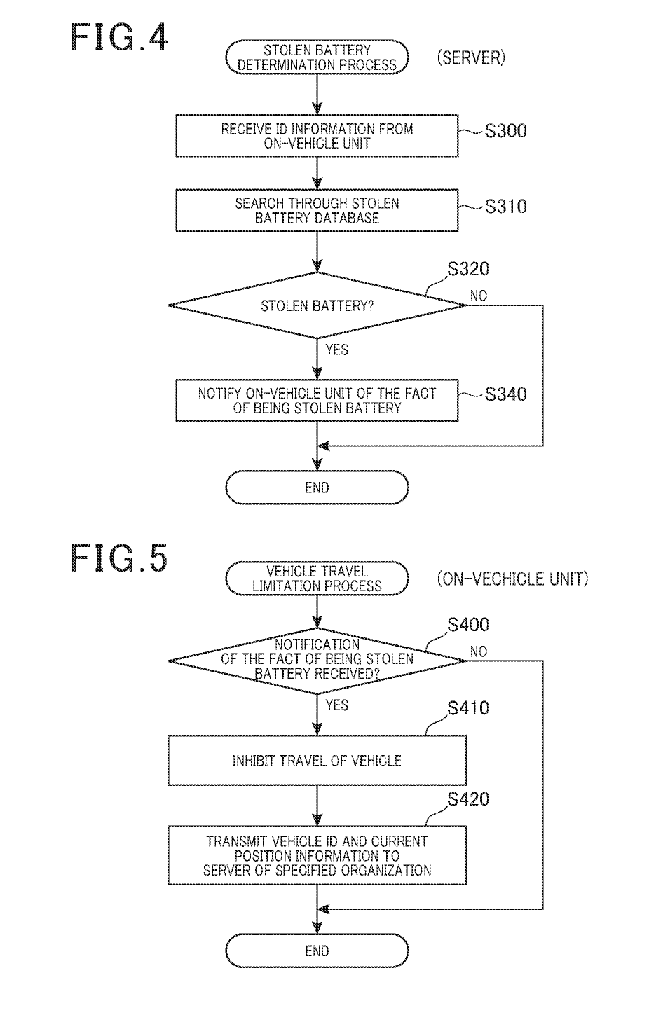

FIG. 4 is a flow diagram illustrating a stolen battery determination process performed in the external server 20. The stolen battery determination process is periodically performed in the external server 20, or performed when ID information is received from the on-vehicle unit 10.

At step S300, the ID information of the battery 12 transmitted from the on-vehicle unit 10 is received. At step S310, the external server 20 searches through the stolen battery data base to find whether ID information identical with the ID information of the battery 12 as received is registered in the data base. Then, at step S320, it is determined whether or not the battery 12 having the ID information as received is a stolen battery, based on the results of the search. In this determination at step S230, if the battery 12 is determined to be a stolen battery, control proceeds to step S330. If the battery 12 is determined not to be a stolen battery, the flow diagram shown in FIG. 4 is terminated.

At step S330, via the communication device 21 connected to the network 22, the external server 20 gives a notification regarding the fact of being a stolen battery to the on-vehicle unit 10 that has transmitted the ID information.

FIG. 5 is a flow diagram illustrating a vehicle travel limitation process performed in the on-vehicle unit 10. The vehicle travel limitation process is performed in the case where the ID information is transmitted to the external server 20 in the verification process shown in FIG. 3.

At step S400, it is determined whether or not a notification regarding the fact of being a stolen battery has been received from the external server 20. For example, in the determination at this step S400, an affirmative determination (Yes) is made if a notification regarding the fact of being a stolen battery is received within a predetermined time from when the ID information of the battery 12 has been transmitted to the external server 20. Also, a negative determination (No) is made if the notification is not received within the predetermined time. If an affirmative determination is made, control proceeds to step S410. If a negative determination is made, the process shown in the flow diagram of FIG. 5 is terminated. In other words, if the battery 12 is determined not to be a stolen battery, the on-vehicle unit 10 permits travel of the vehicle.

On the other hand, if the battery 12 is determined to be a stolen battery, control proceeds to step S410. At step S410, inhibition of the travel of the vehicle is instructed to the travel controller 17. In this case, for example, the travel controller 17 inhibits the vehicle from traveling by stopping current supply to the electric motor.

At the subsequent step S420, the vehicle ID read from the vehicle ID memory 16 and the current position information acquired from the navigator 15 are transmitted to the server of the specified organization. Thus, in the specified organization, such as police or a security company, the vehicle having the stolen battery can be easily searched.

Thus, according to the present embodiment, the battery 12 is verified in the on-vehicle unit 10 as to whether it is a correct battery. Accordingly, the battery 12 can be verified at any time as needed, such as when the vehicle is used, without being limited to the time when the battery 12 is charged. If the verification is disapproved, the ID information read from the battery 12 is transmitted to the external server 20. The external server 20, upon reception of the ID information of the battery 12 from the on-vehicle unit 10, searches through the data base as to whether the battery is a stolen battery, and notifies the results of the search to the on-vehicle unit 10. Upon reception of a notification regarding the fact of being a stolen battery from the external server 20, the on-vehicle unit 10 puts a limit to the travel of the vehicle with the stolen battery.

Thus, when a stolen battery is installed in a different vehicle, travel of the vehicle with the stolen battery is effectively prevented. In this way, when the battery 12 is stolen for use in a different vehicle, use of the battery 12 becomes no longer possible. Resultantly, batteries can be prevented from being stolen.

An embodiment of the present invention has been described so far. However, the present invention is not limited to the embodiment described above but may be variously modified within a scope not departing from the spirit of the present invention.

For example, in the above embodiment, when a notification regarding the fact of being a stolen battery is received from the external server 20, the on-vehicle unit 10 instructs the travel controller 17 to stop the electric motor for the inhibition of the travel of the vehicle. However, if the vehicle is completely inhibited from traveling, travel of other vehicles may be blocked. Therefore, alternatively, the on-vehicle unit 10, when receiving a notification regarding the fact of being a stolen battery from the external server 20, may instruct the travel controller 17 to limit the travel speed of the vehicle or to limit travel distance of the motor-drive vehicle to thereby suppress the vehicle from traveling.

In the above embodiment, the verification process for the battery 12 is performed at the start of the use of the vehicle (when a start switch is operated). Alternative to this, the verification process may be performed while the vehicle is in travel, or may be repeated periodically.

In the above embodiment, when a notification regarding the fact of being a stolen battery is received from the external server 20 in the vehicle travel limitation process, transmission of the vehicle ID and the current position information may be repeated periodically.

The present invention may be embodied in other specific forms without departing from the spirit or essential characteristics thereof.

The present embodiment is therefore to be considered in all respects as illustrative and not restrictive, the scope of the present invention being indicated by the appended claims rather than by the foregoing description and all changes which come within the meaning and range of equivalency of the claims are therefore intended to be embraced therein.

What is claimed is:

1. A system for preventing use of an on-vehicle battery that has been stolen, comprising:
a server placed outside the system; and
an on-vehicle unit mounted on a vehicle,
wherein the server comprises:
first communication means for communicating with the on-vehicle unit,
a data base in which data showing identification information about stolen batteries are registered,
receiving means for receiving a request for searching identification information in question about a battery from the on-vehicle unit via the first communication means,
searching means for searching the data base as to whether or not there is the identification information in question which matches the data in the data base, when the receiving means receives the request, and
notifying means for notifying the on-vehicle unit, from which the request has been transmitted, of information showing that the identification information in question reveals a stolen battery, when the searching means finds data in the data base which matches the identification data; and
the on-vehicle unit comprises:
second communication means for communicating with the server,
verifying means for verifying whether or not a battery currently mounted in the vehicle is valid, by reading out the identification information given to the battery and verifying the read-out identification information with identification information previously registered in the on-vehicle unit,
transmitting means for transmitting, via the second communication means, to the server the request about the read-out identification information when it is verified that the battery currently mounted in the vehicle is invalid, and
limiting means for limiting use of the vehicle when it is notified from the server that the identification information in question matches the stolen battery.

2. The system of claim 1, wherein the vehicle comprises a position detector that detects a current position of the vehicle provided with the on-vehicle unit, and
the on-vehicle unit comprises means for transmitting, to a server at a specified organization, both identification information of the vehicle and information showing the current position detected by the position detector, when it is notified from the server that the identification information in question matches the stolen battery.

3. The system of claim 1, wherein the vehicle has a plurality of batteries mounted hereon, and
the verifying means is configured to verify whether or not each of the batteries currently mounted in the vehicle is valid.

4. The system of claim 2, wherein the vehicle has a plurality of batteries mounted hereon, and
the verifying means is configured to verify whether or not each of the batteries currently mounted in the vehicle is valid.

5. An on-vehicle unit mounted on a vehicle, the on-vehicle unit being arranged in a system for preventing use of an unauthorized on-vehicle battery that has been stolen, the system comprising a server placed outside the system, wherein the server communicates with the on-vehicle unit and has a data base in which data showing identification information about stolen batteries are registered, receives a request for searching for identification information in question about a battery from the on-vehicle unit, searches the data base as to whether or not there is the identification information in question which matches the data in the data base when the receiving means receives the request, and notifies the on-vehicle unit, from which the request has been transmitted, of information showing that the identification information in question matches a stolen battery, when it is found that there is the identification information which matches the data,
the on-vehicle unit comprises:
communication means for communicating with the server,
verifying means for verifying whether or not a battery currently mounted in the vehicle is valid, by reading out the identification information given to the battery and verifying the read-out identification information with identification information previously registered in the on-vehicle unit,
transmitting means for transmitting, via the communication means, to the server the request about the read-out identification information when it is verified that the battery currently mounted in the vehicle is invalid, and
limiting means for limiting use of the vehicle when it is notified from the server that the identification information in question matches a stolen battery.

6. The on-vehicle unit of claim 5, wherein the vehicle has a plurality of batteries mounted hereon, and
the verifying means is configured to verify whether or not each of the batteries currently mounted in the vehicle is valid.
